(19) United States
(12) Patent Application Publication
(10) Pub. No.: US 2022/0124290 A1
(43) Pub. Date: Apr. 21, 2022

(54) SYSTEMS AND METHODS FOR MONITORING A VEHICLE BY COLLABORATION OF NEARBY DEVICES

(71) Applicants: Denso International America, Inc., Southfield, MI (US); Toyota Motor North America, Inc., Plano, TX (US)

(72) Inventors: Satoshi Nagao, Bellevue, WA (US); Yohsuke Satoh, Bellevue, WA (US); Masashi Nakagawa, Sunnyvale, CA (US)

(21) Appl. No.: 17/157,344

(22) Filed: Jan. 25, 2021

Related U.S. Application Data
(60) Provisional application No. 63/091,977, filed on Oct. 15, 2020.

(51) Int. Cl. H04N 7/18; G06K 9/00; H04N 5/232

(52) U.S. Cl. CPC H04N 7/185; G06K 9/00771; G06K 9/00832; G06K 2209/15; G06K 9/00791; H04N 5/23203; G06K 2209/23; G06K 9/00335

(57) ABSTRACT

Systems, methods, and other embodiments described herein relate to improving vehicle monitoring using collaboration of nearby devices. In one embodiment, a method includes, responsive to receiving identifying information about a target vehicle in a monitoring device, detecting the target vehicle near to the monitoring device. The method includes acquiring monitoring information about the target vehicle. The method includes providing the monitoring information to a remote device.

### CROSS-REFERENCE TO RELATED APPLICATIONS

This application claims benefit of U.S. Provisional Application No. 63/091,977, filed on, Oct. 15, 2020, which is herein incorporated by reference in its entirety.

### TECHNICAL FIELD

The subject matter described herein relates in general to systems and methods for monitoring a vehicle, and, more particularly, to causing surrounding vehicles of a target vehicle to monitor the target vehicle when the target vehicle is not able to self-monitor.

### BACKGROUND

Incidents involving rented or loaned vehicles can be problematic for vehicle owners. For example, when a car rental service or other owner rents/lends a vehicle to an individual, the rental generally entails various restrictions on the use of the vehicle. Such restrictions may include a ban on smoking, eating, using a phone while driving, animals, additional passengers, and so on. However, enforcing the restrictions can be a dubious task. That is, while some vehicles may include in-cabin monitoring and the ability to wirelessly communicate with a monitoring service, other vehicles that do not include these technologies or for which the systems are not functioning cannot routinely monitor activity within the vehicle. Moreover, outfitting existing fleet vehicles with additional systems, such as a camera and communication systems can be expensive. As such, the vehicle owner is often left without a reasonable way to monitor use of the vehicles.

### SUMMARY

In one embodiment, example systems and methods associated with improving vehicle monitoring using collaboration of nearby devices are disclosed. As previously noted, monitoring and enforcing restrictions on vehicles that are rented/loaned can be a difficult task. As such, vehicles without in-cabin monitoring may be subject to abuse by those that use the vehicles due to the lack of monitoring. However, in one embodiment, a disclosed approach resolves difficulties with the lack of in-cabin monitoring by leveraging surrounding devices, such as nearby vehicles or smart devices (e.g., smartphones), to monitor the target vehicle instead of including such systems within the target vehicle itself. For example, a target vehicle may be in a parking lot or at another location, which a cloud service (e.g., a computerized service associated with the owner) determines according to GPS or another location determining system associated with the target vehicle. The cloud service may then issue a request to monitor the target vehicle. To issue the request, the cloud service identifies registered devices that are nearby the target vehicle and communicates identifying information to at least one of the registered devices that is to act as a monitoring device of the target vehicle.

The registered devices may include other vehicles or, in further implementations, mobile devices, such as smartphones. In any case, the monitoring device receives the identifying information and proceeds to detect the target vehicle in the surrounding environment. In one or more arrangements, the monitoring device uses various techniques to identify the target vehicle within the surrounding environment, such as image recognition and so on. Upon detecting the target vehicle according to the identifying information, the monitoring device acquires monitoring information about the target vehicle. For example, the monitoring device, in at least one approach, captures still images and/or video about the target vehicle. The monitoring device may use the images/video as the monitoring information or may further process the images/video to derive additional determinations about the target vehicle and any passengers therein. That is, the monitoring device may process the images/video to determine current behaviors of the passengers, a condition of the vehicle, and so on.

Accordingly, the monitoring device can then provide the monitoring information including the determinations and/or the derived data to report about the target vehicle. In one or more arrangements, the monitoring device provides the monitoring information by communicating the images/video and/or the determinations to a remote device that is part of the cloud service. The cloud service can then use the monitoring information to determine whether the driver/occupants are abiding by restrictions for using the vehicle. As such, the cloud service may provide an alert to the driver/occupant via a phone call, email, text message or other communication about the observed behaviors in order to mitigate the failure to properly use the target vehicle. As an additional aspect, the cloud service may compensate the monitoring device for performing the noted functions. In this way, the presently disclosed approach improves monitoring of the target vehicle to provide for better enforcement of restrictions when a vehicle is without an explicit in-cabin monitoring system.

In one or more arrangements, a monitoring system is disclosed. The monitoring system includes one or more processors and a memory that is communicably coupled to the one or more processors. The memory stores a detection module including instructions that, when executed by the one or more processors, cause the one or more processors to, responsive to receiving identifying information about a target vehicle in a monitoring device, detect the target vehicle near to the monitoring device. The memory further stores a capture module including instructions that, when executed by the one or more processors, cause the one or more processors to i) acquire monitoring information about the target vehicle, and to ii) provide the monitoring information to a remote device.

In one or more arrangements, a non-transitory computer-readable medium is disclosed. The instructions include instructions to, responsive to receiving identifying information about a target vehicle in a monitoring device, detect the target vehicle near to the monitoring device. The instructions include instructions to acquire monitoring information about the target vehicle. The instructions include instructions to provide the monitoring information to a remote device.

In one or more arrangements, a method is disclosed. The method may include, responsive to receiving identifying information about a target vehicle in a monitoring device, detecting the target vehicle near to the monitoring device. The method includes acquiring monitoring information about the target vehicle. The method includes providing the monitoring information to a remote device.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a vehicle in which example systems and methods disclosed herein may operate.

FIG. 2 illustrates one embodiment of a monitoring system that is associated with improving monitoring of a target vehicle.

FIG. 3 illustrates an example of a cloud-computing environment in which disclosed systems and methods may operate.

FIG. 4 illustrates an example of a monitoring device observing a target vehicle.

FIG. 5 illustrates one embodiment of a method associated with monitoring a target vehicle.

FIG. 6 illustrates a diagram that details an example of communications exchanged between different entities.

### DETAILED DESCRIPTION

Systems, methods, and other embodiments associated with improving vehicle monitoring using collaboration of nearby devices are disclosed. As previously noted, vehicles without in-cabin monitoring may be subject to abuse by those that use the vehicles due to the lack of oversight during use. Accordingly, in one embodiment, a monitoring system resolves difficulties with the lack of in-cabin monitoring by leveraging surrounding devices, such as nearby vehicles or smart devices (e.g., smartphones), to monitor the target vehicle instead of including such systems within the target vehicle itself. For example, a target vehicle may be in a parking lot, driving along a roadway, or at another location, which a cloud service determines according to GPS or other location determining system associated with the target vehicle.

The cloud service is generally associated with a monitoring entity, such as a car rental company, a car share company, an individual owner, and so on. The cloud service may issue a request to monitor the target vehicle. To issue the request, the cloud service identifies registered devices that are nearby the target vehicle from a map that indicates locations of the target vehicle relative to the registered devices. Thus, the registered devices may periodically report locations to the cloud service in order to facilitate identifying which are close to the target vehicle. In any case, the monitoring system communicates identifying information to at least one of the registered devices that is to act as a monitoring device of the target vehicle. The identifying information can include a license plate number, a physical description of the target vehicle (e.g., color, make, model, etc.), a current location of the target vehicle, and so on.

The registered devices may include other vehicles or, in further implementations, mobile devices, such as smartphones. In any case, the monitoring device receives the identifying information and proceeds to detect the target vehicle in the surrounding environment. In one or more arrangements, the monitoring device uses various techniques to identify the target vehicle within the surrounding environment, such as image recognition and so on. The monitoring system may implement the image recognition using one or more machine learning algorithms. Upon detecting the target vehicle according to the identifying information (e.g., localizing the target vehicle in the surrounding environment), the monitoring device acquires monitoring information about the target vehicle. For example, the monitoring device, in at least one approach, captures still images and/or video about the target vehicle. The monitoring device may use the images/video as the monitoring information or may further process the images/video to derive additional determinations about the target vehicle and any passengers therein. That is, the monitoring device may process the images/video to determine current behaviors of the passengers, a condition of the vehicle, and so on.

Accordingly, the monitoring device can then provide the monitoring information including the determinations and/or the derived data to report about the target vehicle. In one or more arrangements, the monitoring device provides the monitoring information by communicating the images/video and/or the determinations to a remote device that is part of the cloud service. The cloud service can then use the monitoring information to determine whether the driver/occupants are abiding by restrictions for using the vehicle. As such, the cloud service may provide an alert to the driver/occupant via a phone call, email, text message or other communication about the observed behaviors in order to mitigate the failure to properly use the target vehicle. As an additional aspect, the cloud service may compensate the monitoring device for performing the noted functions. In this way, the presently disclosed approach improves monitoring of the target vehicle to provide for better enforcement of restrictions when a vehicle is without an explicit in-cabin monitoring system.

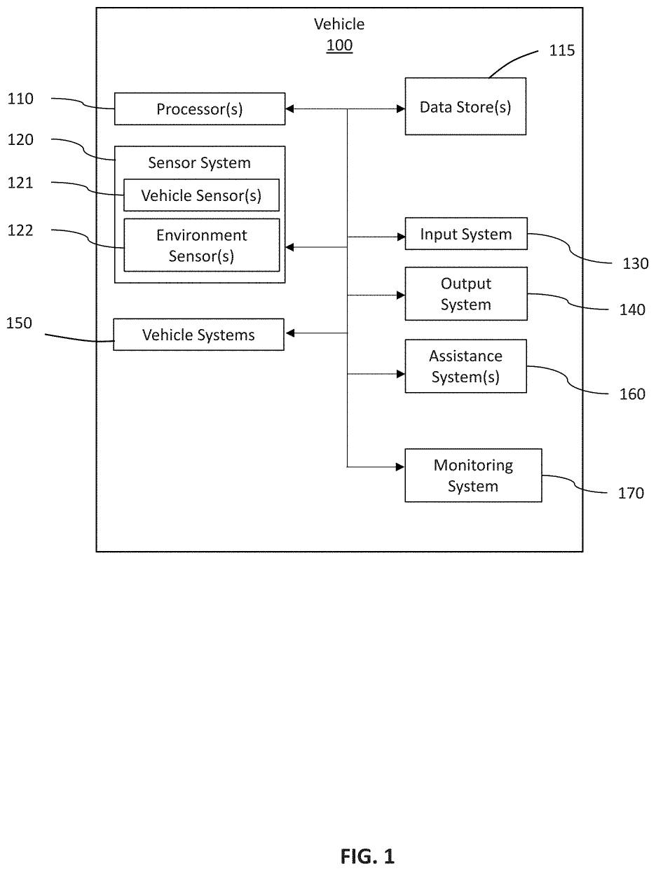

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. For example, in some implementations, the monitoring system 170 may be implemented in a different device, such as a smartphone, camera, security-monitoring camera, or another device that is equipped with systems for performing the noted functions.

In any case, the vehicle 100 also includes various elements. It will be understood that, in various embodiments, the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

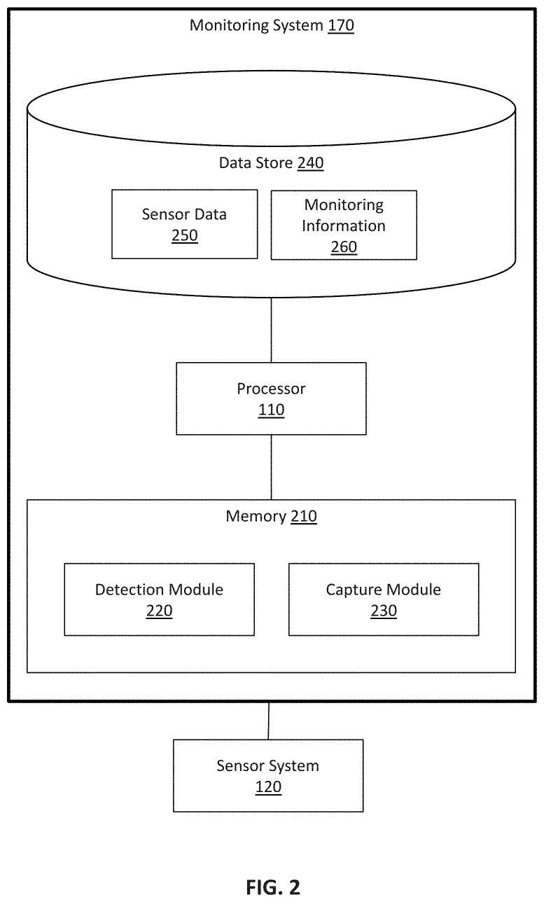

Some of the possible elements of the vehicle 100 are shown in FIG. 1 and will be described along with subsequent figures. A description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In either case, the vehicle 100 includes the monitoring system 170 that functions to report about activities of a target vehicle at the request of a cloud service. Moreover, while depicted as a standalone component, in one or more embodiments, the monitoring system 170 is integrated with the assistance system 160, or another similar system of the vehicle 100 as a sub-component thereof. The noted functions and methods will become more apparent with a further discussion of the figures.

With reference to FIG. 2, one embodiment of the monitoring system 170 is further illustrated. As shown, the monitoring system 170 includes a processor 110. Accordingly, the processor 110 may be a part of the monitoring system 170, or the monitoring system 170 may access the processor 110 through a data bus or another communication pathway. In one or more embodiments, the processor 110 is an application-specific integrated circuit that is configured to implement functions associated with a detection module 220 and a capture module 230. More generally, in one or more aspects, the processor 110 is an electronic processor such as a microprocessor that is capable of performing various functions as described herein when executing encoded functions associated with the monitoring system 170.

In one embodiment, the monitoring system 170 includes a memory 210 that stores the detection module 220 and the capture module 230. The memory 210 is a random-access memory (RAM), read-only memory (ROM), a hard disk drive, a flash memory, or other suitable memory for storing the modules 220 and 230. The modules 220 and 230 are, for example, computer-readable instructions that, when executed by the processor 110, cause the processor 110 to perform the various functions disclosed herein. While, in one or more embodiments, the modules 220 and 230 are instructions embodied in the memory 210, in further aspects, the modules 220 and 230 include hardware, such as processing components (e.g., controllers), circuits, etcetera for independently performing one or more of the noted functions. In any case, it should be appreciated that the instructions of the modules 220 and 230 impart structure to the monitoring system 170 through correlations of opcodes with the processor 110 and memory in which the monitoring system 170 stores the instructions.

Furthermore, in one embodiment, the monitoring system 170 includes a data store 240. The data store 240 is, in one embodiment, an electronically-based data structure for storing information. In one approach, the data store 240 is a database that is stored in the memory 210 or another suitable storage medium, and that is configured with routines that can be executed by the processor 110 for analyzing stored data, providing stored data, organizing stored data, and so on. In any case, in one embodiment, the data store 240 stores data used by the modules 220 and 230 in executing various functions. In one embodiment, the data store 240 includes sensor data 250, and monitoring information 260 along with, for example, other information that is used by the modules 220 and 230.

Accordingly, the detection module 220 generally includes instructions that function to control the processor 110 to acquire data inputs from one or more sensors (e.g., the LiDAR sensor 123) of the vehicle 100 that form the sensor data 250. In general, the sensor data 250 includes information that embodies observations of the surrounding environment of the vehicle 100. The observations of the surrounding environment, in various embodiments, can include surrounding lanes, vehicles, objects, obstacles, etc. that may be present in the lanes, proximate to a roadway, within a parking lot, garage structure, driveway, or another area within which the vehicle 100 is operating.

While the detection module 220 is discussed as controlling the various sensors to provide the sensor data 250, in one or more embodiments, the detection module 220 can employ other techniques to acquire the sensor data 250 that are either active or passive. For example, the detection module 220 may passively sniff the sensor data 250 from a stream of electronic information provided by the various sensors to further components within the vehicle 100. Moreover, the detection module 220 can undertake various approaches to fuse data from multiple sensors when providing the sensor data 250. Thus, the sensor data 250, in one embodiment, represents a combination of perceptions acquired from multiple sensors. Thus, whether the sensor data 250 is derived from a single sensor or multiple sensors, the sensor data 250 is comprised of information about a surrounding environment from which the monitoring system 170 can monitor a target vehicle to report about behaviors of the target vehicle.

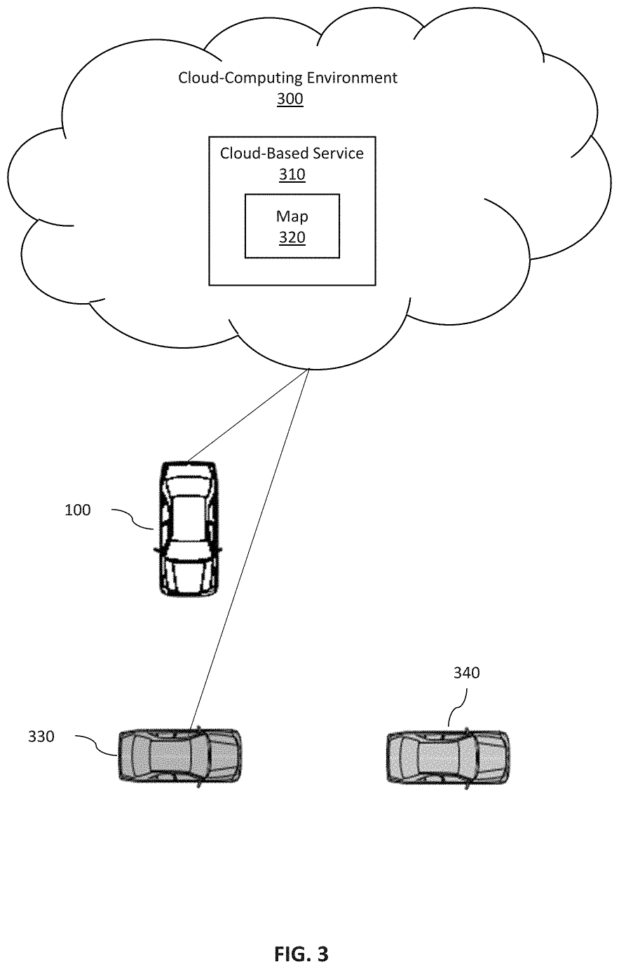

As an additional explanation of the general premise of monitoring a target vehicle by a monitoring device, such as another vehicle, FIG. 3 will now be addressed. FIG. 3 illustrates one example of a cloud-computing environment 300 that may be implemented along with the monitoring system 170. As illustrated in FIG. 3, a cloud-based service 310, which may be embodied, in part, as the monitoring system 170, communicates with the vehicle 100. In any case, the cloud-based service 310 is a service associated with an originator of a target vehicle 330. That is, the cloud-based service 310 is associated with a car manufacturer, a car rental company, a car share company, or a service for monitoring personally owned vehicles. Whatever the circumstance, the cloud-based service 310 registers potential monitoring devices, such as the vehicle 100, or other non-vehicle devices (e.g., smartphones). The cloud-based service 310 may periodically communicate with the monitoring devices (e.g., vehicle 100, vehicle 340, etc.) and the target vehicle 330 to determine locations from which the cloud-based service 310 generates a map 320.

The map 320, in at least one configuration, tracks locations of the separate entities so that the cloud-based service 310 can identify a monitoring device that is able to monitor the target vehicle 330. Thus, in various approaches, the cloud-based service 310 may consider the proximity of the target vehicle 100 with potential monitoring devices, a current trajectory of the target vehicle 330 (e.g., derived from position history), a current trajectory of the potential monitoring devices, and other information that informs the cloud-based service 310 about which monitoring device may be best suited for encountering and monitoring the target vehicle 330. That is, the cloud-based service 310 may use information about locations and likely future locations extrapolated from the trajectories to determine which monitoring device is best suited to rendezvous with the target vehicle 330.

In any case, the cloud-based service 310 stores identifying information about the target vehicle 330 in order to facilitate detecting the target vehicle 330 by a monitoring device. The identifying information can include a license plate number, a physical description of the target vehicle 330 (e.g., make, model, color, etc.), a location, or any combination of the noted aspects. Thus, the cloud-based service 310 may automatically, at defined intervals, or manually, at the indication of the owner of the target vehicle 330, generate a request to monitor the target vehicle 330. As such, the cloud-based service 310 generates and transmits a communication to a selected monitoring device, which in the example scenario is the target vehicle 100. Moreover, as illustrated by the line extending from the cloud to the vehicle 330, the cloud-based service 310 may provide notifications to the vehicle 330 and/or to an electronic device (e.g., a smartphone) of a user of the vehicle 100. The notification may indicate aspects observed by the vehicle 100 about use of the vehicle 330. Further, the cloud-based service 310 may track the vehicle 330 via communications between the cloud and the vehicle 330 and/or the electronic device. Further discussion of the monitoring process will now transition back to FIG. 2.

The detection module 220 receives the communication from the cloud-based service 310, including the identifying information. Accordingly, the detection module 220 then proceeds to, in at least one arrangement, detect the target vehicle 330. In one approach, the detection module 220 may detect the target vehicle by, at least initially, causing the vehicle 100 to move to a location specified by the identifying information. Moving to the location may include causing the vehicle 100 to autonomously drive to the location, providing instructions to an operator of the vehicle 100, etc. In the instance when the monitoring device is not a vehicle, then the detection module 220 may provide instructions to a user to move to the location and/or to point the monitoring device in a direction of the location.

Once the monitoring device (i.e., the vehicle 100) is within an observable distance of the target vehicle 330, then the detection module 220 proceeds to acquire monitoring information about the target vehicle 330. In one or more arrangements, the detection module 220 acquires sensor data 250 that includes images of the target vehicle 330 or at least of an area that the detection module 220 believes to be associated with the target vehicle 330. In a further arrangement, the detection module 220 acquires video as part of the sensor data 250 instead of still images. Additionally, while images/video are discussed, the detection module 220 may use further information that is available within the vehicle 100, such as data from radar, LiDAR, ultrasonic sensors, and so on. In any case, the detection module 220 uses one or more processing routines to process the images and/or video and identify the target vehicle. The processing routines may include routines for object instance segmentation, classification, license plate recognition, and/or other image processing routines that support detecting the target vehicle 330. Thus, the noted processing routines may be machine learning algorithms, such as artificial neural networks (e.g., convolutional neural networks, recurrent neural networks, generative neural networks, and other deep neural networks).

The detection module 220, in one or more approaches, verifies the detection of the target vehicle 330 in the sensor data 250 according to a threshold correlation. That is, if a definitive identification through a license plate number is not possible because of a pose of the vehicle 100 relative to the target vehicle 330, environment conditions, or another reason, then the detection module 220 verifies the detection of the target vehicle 330 according to a correspondence in location and general physical features of the vehicle 330.

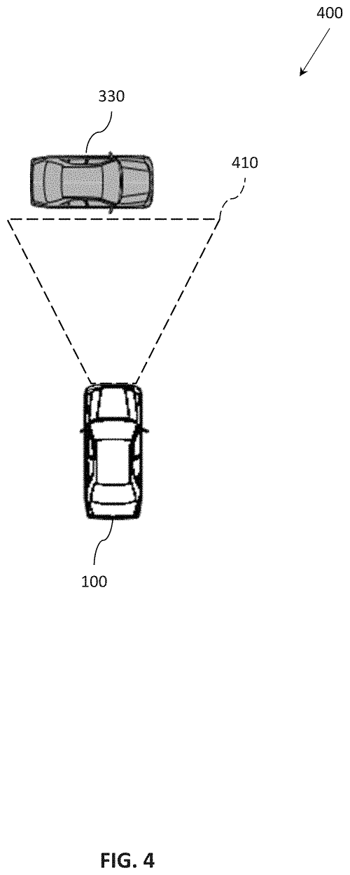

Upon verifying the detection of the target vehicle 330, the capture module 230 acquire monitoring information about the target vehicle 330. Briefly consider FIG. 4, which illustrates an example encounter 400 of the vehicle 100 with the target vehicle 330. The vehicle 100 may use a forward-facing camera of the vehicle 100 with a field of view 410 that captures the target vehicle 330. Accordingly, the monitoring device (i.e., the vehicle 100 in this case) may have a side view, a front view, or a rear view of the target vehicle 100. In general, any view of the target vehicle 330 is adequate, but the capture module 230 may adjust the operation of the vehicle 100 or, when possible, orient a camera sensor to capture occupants of the vehicle 330.

In any case, the capture module 230 acquires images and/or video of the vehicle 100. The capture module 230 may use the raw images/video as the monitoring information or may perform additional processing of the images/video to derive additional determinations. For example, similar to detecting the target vehicle 330, the capture module 230, in one or more arrangements, employs processing routines, such as machine learning algorithms, to process the images/video and determine activities of the occupants, a condition of the target vehicle 330, and so on. Thus, the capture module 230 may identify restricted actions, such as eating, smoking, an excessive number of passengers, use of electronic devices (e.g., cellular phones), failure to wear seatbelts, and so on. In general, whichever behaviors/circumstances the capture module 230 is capable of identifying about the target vehicle 330 may be captured in the monitoring information.

Consequently, the capture module 230, in one or more approaches, then provides the monitoring information to the cloud-based service 310 via wireless electronic communications. Depending on the particular behaviors/circumstances that the capture module 230 identifies, the capture module 230 may communicate different information to a remote device of the cloud-based service 310. For example, when the capture module 230 analyzes the images/video but does not resolve any restricted behaviors/circumstances, then the capture module 230 may communicate a simple response that indicates no restricted behaviors/circumstances are taking place.

In a further aspect, the capture module 230 may communicate the derived information as the monitoring information, while in further circumstances, the capture module 230 may include at least segments of the images and/or video that depicts the behaviors/circumstances. In still a further implementation, the capture module 230 may communicate images/video without derived information where the vehicle 100 does not have the resources to process the images/video. Moreover, in further instances, the capture module 230 dynamically determines which information to communicate according to available computational resources and/or communication bandwidth, which may result in throttling the processing of the images/video and/or the communication of the images/video. In any case, the monitoring system 170 is able to improve monitoring of the target vehicle 330 by reporting the monitoring information to the cloud-based service and thereby facilitate resolving difficulties with monitoring vehicles that do not include in-cabin monitoring systems.

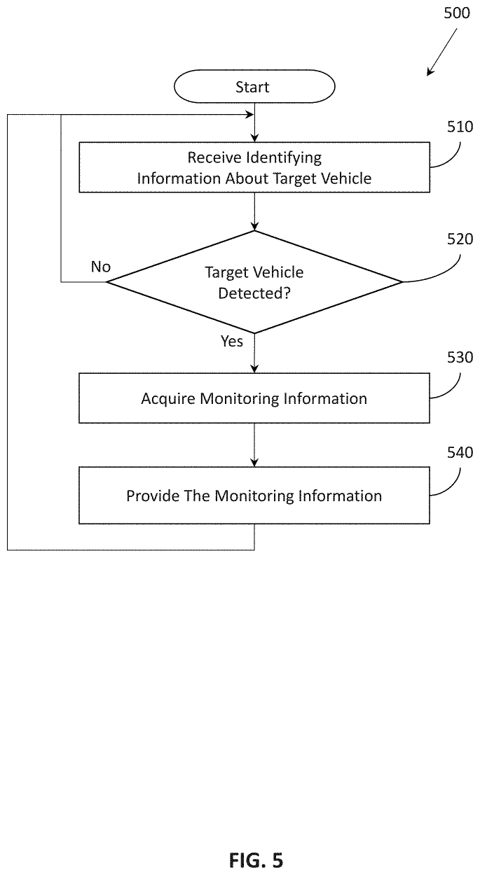

Additional aspects of improving monitoring of a target vehicle will be discussed in relation to FIG. 5. FIG. 5 illustrates a method 500 associated with monitoring a target vehicle through collaboration of nearby devices. Method 500 will be discussed from the perspective of the monitoring system 170 of FIG. 1. While method 500 is discussed in combination with the monitoring system 170, it should be appreciated that the method 500 is not limited to being implemented within the monitoring system 170 but is instead one example of a system that may implement the method 500.

At 510, the monitoring device (e.g., the vehicle 100) receives identifying information about a target vehicle. As previously set forth, the target vehicle is a vehicle that is to be monitored by the monitoring device. Accordingly, the identifying information is generally part of a communication from the cloud-based service to the monitoring device that includes the identifying information as a request to monitor the target device. In one or more arrangements, the identifying information may include various information, such as a license plate number, a current location, and a physical appearance of the target vehicle. In further approaches, the identifying information may also include information about the driver. In any case, the remote device, such as a server or other computing device associated with the cloud-based service, communicates the identifying information to the monitoring device upon selection for monitoring the target vehicle. Thus, when the monitoring device receives the identifying information, the identifying information then induces the monitoring device to proceed with the method 500. Of course, in further approaches, the monitoring device may provide a notification to a user (e.g., a driver) for approval prior to proceeding with subsequent steps. In any case, the cloud-based service initially provides the identifying information to the monitoring device to cause the monitoring device to take actions to monitor the target vehicle, as explained in greater detail in the following discussion.

At 520, the detection module 220 uses the identifying information to detect the target vehicle. For example, in at least one approach, the detection module 220 detects the target vehicle near to the monitoring device by using the sensor data 250 to discern the target vehicle from the surrounding environment. In one approach, the detection module 220 implements a set of machine learning algorithms (e.g., artificial neural networks) that process images and/or video from a camera (e.g., a camera of sensor system 120) of the monitoring device to perform object detection, object recognition, behavior detection, license plate identification, and so on. Thus, the detection module 220 may identify separate vehicles in the surrounding environment and then use the identifying information to determine which of the identified vehicles corresponds with the target vehicle.

Accordingly, it should be appreciated that the detection module 220 acquires the sensor data 250 from at least one sensor of the target vehicle 100. In one embodiment, the detection module 220 acquires the sensor data 250 about a surrounding environment of the vehicle 100. As previously noted, the detection module 220, in one or more implementations, iteratively acquires the sensor data 250 from one or more sensors of the sensor system 120 to which the monitoring system 170 is communicatively coupled. The sensor data 250 includes observations of a surrounding environment of the target vehicle 100, which may include a forward area and/or other regions about the vehicle 100 depending on available sensors.

In general, the detection module 220 processes the sensor data 250 according to the set of machine learning algorithms that identify separate instances of objects in the surrounding environment and may further classify the instances according to a classifier to identify a semantic class. Moreover, the detection module 220 is processing the sensor data 250 to generally identify separate aspects of the surrounding environment and determine a specific location of the target vehicle relative to the vehicle 100. Accordingly, if the detection module 220 detects the target vehicle, then the monitoring system proceeds to acquire monitoring information, as discussed at block 530. Otherwise, the detection module 220 may halt the monitoring when the target vehicle is not detected.

At 530, the capture module 230 acquires monitoring information about the target vehicle. In at least one arrangement, the capture module 230 acquires and uses the sensor data 250, as noted above. For example, the capture module 230, in one or more arrangements, causes a camera of the monitoring device (e.g., vehicle 100) to capture images and/or video of the target vehicle. While the images/video may be used as the monitoring information, the capture module 230, in various arrangements, performs additional processing on the image/video. The capture module 230 may analyze images/video of the target vehicle to identify activities of an occupant of the target vehicle and a condition of the target vehicle. Thus, the capture module 230 derives additional information from the images/video. The derived information, which may also be included as the monitoring information or part of the monitoring information, indicates features captured within the images/video.

In general, the capture module 230 is analyzing the images/video in order to derive information related to the restrictions associated with using the target vehicle. Thus, the capture module 230 may execute different machine learning algorithms that are configured to identify different aspects of the images/video. For example, different algorithms may identify passengers in the target vehicle, behaviors of the passengers, the presence of unauthorized items/animals, particular behaviors of the passengers (e.g., smoking, eating, etc.). In any case, the capture module 230 acquires the monitoring information by acquiring the images/video and/or deriving determinations therefrom.

At 540, the capture module 230 provides the monitoring information to a remote device. The remote device is a device, such as a server or set of servers that function to facilitate the cloud-based service. Thus, the remote device is generally located remotely from the monitoring device and the target vehicle. Of course, in further approaches, the remote device may be an individual device associated with an individual owner that is lending the target vehicle. In either case, the capture module 230 provides the monitoring information in order to improve reporting about the target vehicle when the target vehicle is unable to monitor itself and/or communicate such information directly to the remote device.

The capture module 230 may provide the monitoring information as a single report or on an ongoing basis as able. For example, the capture module 230 may monitor the target vehicle for an extended period of time and provide multiple separate communications, including the monitoring information. In one or more aspects, the capture module 230 may provide the monitoring information as the monitoring device (e.g., the vehicle 100) follows the target vehicle along a roadway. Once the capture module 230 acquires the monitoring information, the capture module 230 may provide the monitoring information by electronically communicating the monitoring information to the remote device to report on behaviors of an occupant of the target vehicle. The electronic communication may take different forms depending on the implementation but generally can include cellular communication, WIFI, and so on. In this way, the monitoring system 170 improves the ability of the target vehicle to report about activities occurring therein and, thus, avoids the noted difficulties.

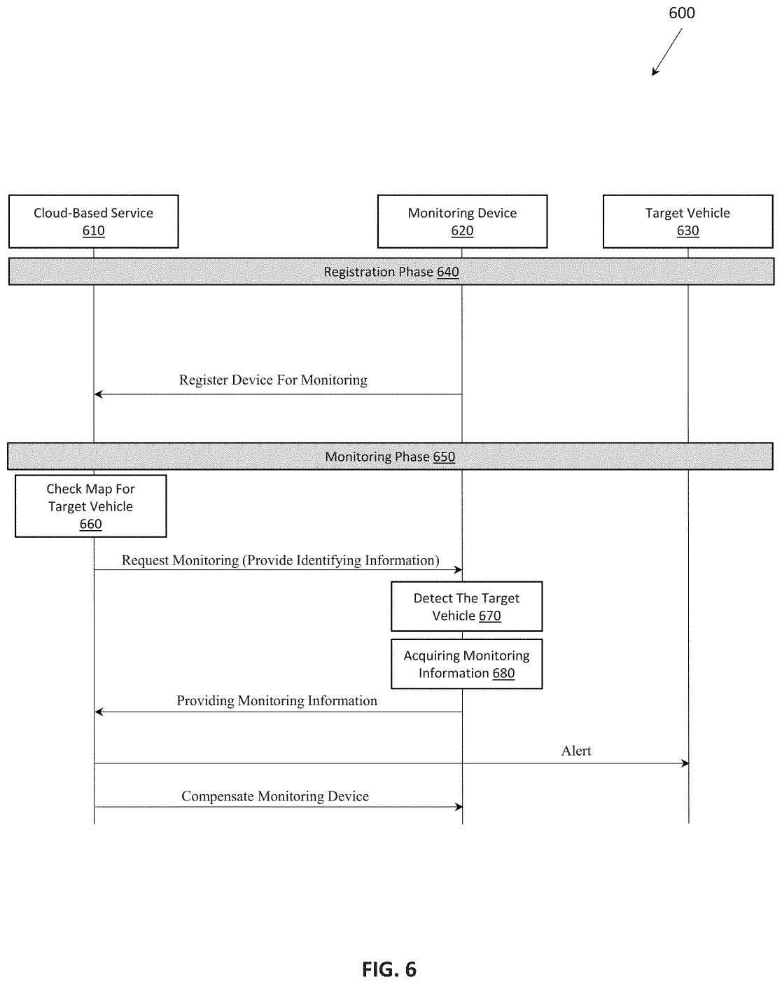

As a further explanation of how the presently disclosed systems and methods function, consider FIG. 6. FIG. 6 illustrates a diagram 600 of the different stages and communications involved with monitoring as discussed herein. As shown in the diagram 600, three separate actors are involved in the noted process. As shown, a cloud-based service 610, a monitoring device 620, and a target vehicle 630 interact as part of the monitoring. Initially, the monitoring device 620 registers as part of a registration phase 640. The monitoring device 620 provides a communication to the cloud-based service 610 that registers the monitoring device 620 for subsequent monitoring events. The communication may include identifying information about the monitoring device 620, and other useful information for tracking and communicating with the monitoring device 620.

Upon registering, the monitoring device 620 is actively considered as a potential source for monitoring target vehicles, such as the target vehicle 630 depending on relative locations. Accordingly, during a monitoring phase 650, the cloud-based service 610 uses a map to determine available monitoring devices for monitoring the target vehicle 630 as shown at 660. The cloud-based service may consider a radius about the target vehicle 630 and determine which devices are present therein. Further selection may rely on relative trajectories and/or other information. In any case, the cloud-based service 610 selects the monitoring device 620 to monitor the target vehicle 630 and, thus, communicates the identifying information to the monitoring device 620 as part of the request. The monitoring device 620 may then undertake various functions, such as detecting the target vehicle 670 and acquiring the monitoring information 680 prior to communicating the monitoring information back to the cloud-based service 610.

After receiving the monitoring information, the cloud-based service can then, for example, provide a notification to the target vehicle 630, such as an alert, a warning, or another message. While the diagram 600 illustrates an alert provided to the target vehicle 630, in various circumstances, the notification/alert may be provided to a device associated with the target vehicle 630 or a user of the target vehicle 630. Thus, the communication may be provided to a smartphone of the user that is within the target vehicle 630, to an infotainment system of the target vehicle 630 itself, and so on.

Moreover, the cloud-based service 610 may further compensate the monitoring device 620 for monitoring the target vehicle 630. The compensation may be monetary or may take other forms, such as reduce rates, gifts, and so on. In any case, the process of compensating the monitoring device 620 generally involves a quid pro quo of the monitoring information for direct compensation in order to facilitate enrolling as many monitoring devices as may be practical since a larger network of monitoring devices is more likely to result in a monitoring device being with a reasonable distance of a target vehicle at any given time.

Additionally, it should be appreciated that the monitoring system 170 from FIG. 1 can be configured in various arrangements with separate integrated circuits and/or electronic chips. In such embodiments, the detection module 220 is embodied as a separate integrated circuit. Additionally, the capture module 230 is embodied on an individual integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In another embodiment, the modules 220 and 230 may be combined into a separate application-specific integrated circuit. In further embodiments, portions of the functionality associated with the modules 220 and 230 may be embodied as firmware executable by a processor and stored in a non-transitory memory. In still further embodiments, the modules 220 and 230 are integrated as hardware components of the processor 110.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the systems and methods disclosed herein may operate. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the monitoring system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 240) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps. In one or more arrangements, the map data can include one or more static obstacle maps. The static obstacle map(s) can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level.

The one or more data stores 115 can include sensor data (e.g., sensor data 250). In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and /or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements, or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1; however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the monitoring system 170, and/or the assistance system 160 can be operatively connected to communicate with the various vehicle systems 150 and/or individual components thereof. For example, returning to FIG. 1, the processor(s) 110 and/or the assistance system 160 can be in communication to send and/or receive information from the various vehicle systems 150 to control the movement, speed, maneuvering, heading, direction, etc. of the vehicle 100. The processor(s) 110, the monitoring system 170, and/or the assistance system 160 may control some or all of these vehicle systems 150 and, thus, may be partially or fully autonomous.

The processor(s) 110, the monitoring system 170, and/or the assistance system 160 can be operatively connected to communicate with the various vehicle systems 150 and/or individual components thereof. For example, returning to FIG. 1, the processor(s) 110, the monitoring system 170, and/or the assistance system 160 can be in communication to send and/or receive information from the various vehicle systems 150 to control the movement, speed, maneuvering, heading, direction, etc. of the vehicle 100. The processor(s) 110, the monitoring system 170, and/or the assistance system 160 may control some or all of these vehicle systems 150.

The processor(s) 110, the monitoring system 170, and/or the assistance system 160 may be operable to control the navigation and/or maneuvering of the vehicle 100 by controlling one or more of the vehicle systems 150 and/or components thereof. For instance, when operating in an autonomous mode, the processor(s) 110, the monitoring system 170, and/or the assistance system 160 can control the direction and/or speed of the vehicle 100. The processor(s) 110, the monitoring system 170, and/or the assistance system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the monitoring system 170 and/or the assistance system 160 can function to perform various driving-related tasks. The vehicle 100 can include one or more actuators. The actuators can be any element or combination of elements operable to modify, adjust and/or alter one or more of the vehicle systems or components thereof to responsive to receiving signals or other inputs from the processor(s) 110 and/or the assistance system 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include an assistance system 160. The assistance system 160 can be configured to receive data from the sensor system 120 and/or any other type of system capable of capturing information relating to the vehicle 100 and/or the external environment of the vehicle 100. In one or more arrangements, the assistance system 160 can use such data to generate one or more driving scene models. The assistance system 160 can determine the position and velocity of the vehicle 100. The assistance system 160 can determine the location of obstacles, or other environmental features, including traffic signs, trees, shrubs, neighboring vehicles, pedestrians, and so on.

The assistance system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system 160, either independently or in combination with the monitoring system 170, can be configured to determine travel path(s), current autonomous driving maneuvers for the vehicle 100, future autonomous driving maneuvers, and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system 160 can be configured to implement determined driving maneuvers. The assistance system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that, when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A monitoring system, comprising:
one or more processors;
a memory communicably coupled to the one or more processors and storing:
a detection module including instructions that, when executed by the one or more processors, cause the one or more processors to, responsive to receiving identifying information about a target vehicle in a monitoring device, detect the target vehicle near to the monitoring device; and
a capture module including instructions that, when executed by the one or more processors, cause the one or more processors to i) acquire monitoring information about the target vehicle, and to ii) provide the monitoring information to a remote device.

2. The monitoring system of claim 1, wherein the capture module includes instructions to acquire the monitoring information including instructions to cause a camera of the monitoring device to capture at least one of images and video of the target vehicle.

3. The monitoring system of claim 1, wherein the capture module includes instructions to acquire the monitoring information including instructions to analyze images of the target vehicle to identify activities of an occupant of the target vehicle and a condition of the target vehicle.

4. The monitoring system of claim 1, wherein the detection module includes instructions to detect the target vehicle including instructions to use the identifying information to identify the target vehicle in a surrounding environment of the monitoring device, and
wherein the identifying information includes one or more of a license plate number, a location, and a physical appearance of the target vehicle.

5. The monitoring system of claim 1, wherein the detection module includes instructions to detect the target vehicle and acquire the monitoring information including instructions to process images from a camera of the monitoring device using machine learning algorithms that perform object detection, object recognition, and behavior detection.

6. The monitoring system of claim 1, wherein the detection module includes instructions to receive the identifying information in the monitoring device including instructions to receive the identifying information by one of a vehicle and a smartphone, and
wherein the detection module includes instructions to receive the identifying information including instructions to receive the identifying information from a cloud-based device associated with the remote device to cause the monitoring device to monitor the target vehicle.

7. The monitoring system of claim 1, wherein the capture module includes instructions to provide the monitoring information to the remote device including instructions to electronically communicate the monitoring information to the remote device to report on behaviors of an occupant of the target vehicle.

8. The monitoring system of claim 1, wherein the capture module includes instructions to provide the monitoring information to improve reporting about the target vehicle when the target vehicle is unable to communicate the monitoring information to the remote device.

9. A non-transitory computer-readable medium storing instructions that, when executed by one or more processors, cause the one or more processors to:
responsive to receiving identifying information about a target vehicle in a monitoring device, detect the target vehicle near to the monitoring device;
acquire monitoring information about the target vehicle; and
provide the monitoring information to a remote device.

10. The non-transitory computer-readable medium of claim 9, wherein the instructions to acquire the monitoring information include instructions to cause a camera of the monitoring device to capture at least one of images and video of the target vehicle, and
wherein the instructions to acquire the monitoring information include instructions to analyze images of the target vehicle to identify activities of an occupant of the target vehicle and a condition of the target vehicle.

11. The non-transitory computer-readable medium of claim 9, wherein the instructions to detect the target vehicle include instructions to use the identifying information to identify the target vehicle in a surrounding environment of the monitoring device, and
wherein the identifying information includes one or more of a license plate number, a location, and a physical appearance of the target vehicle.

12. The non-transitory computer-readable medium of claim 9, wherein the instructions to detect the target vehicle and acquire the monitoring information include instructions to process images from a camera of the monitoring device using machine learning algorithms that perform object detection, object recognition, and behavior detection.

13. The non-transitory computer-readable medium of claim 9, wherein the instructions to receive the identifying information in the monitoring device include instructions to receive the identifying information by one of a vehicle and a smartphone, and
wherein the instructions to receive the identifying information include instructions to receive the identifying information from a cloud-based device associated with the remote device to cause the monitoring device to monitor the target vehicle.

14. A method, comprising:
responsive to receiving identifying information about a target vehicle in a monitoring device, detecting the target vehicle near to the monitoring device;
acquiring monitoring information about the target vehicle; and
providing the monitoring information to a remote device.

15. The method of claim 14, wherein acquiring the monitoring information includes causing a camera of the monitoring device to capture at least one of images and video of the target vehicle.

16. The method of claim 14, wherein acquiring the monitoring information includes analyzing images of the target vehicle to identify activities of an occupant of the target vehicle and a condition of the target vehicle.

17. The method of claim 14, wherein detecting the target vehicle includes using the identifying information to identify the target vehicle in a surrounding environment of the monitoring device, and
wherein the identifying information includes one or more of a license plate number, a location, and a physical appearance of the target vehicle.

18. The method of claim 14, wherein detecting the target vehicle and acquiring the monitoring information include processing images from a camera of the monitoring device using machine learning algorithms that perform object detection, object recognition, and behavior detection.

19. The method of claim 14, wherein receiving the identifying information in the monitoring device includes receiving the identifying information by one of a vehicle and a smartphone, and
wherein receiving the identifying information includes receiving the identifying information from a cloud-based device associated with the remote device to cause the monitoring device to monitor the target vehicle.

20. The method of claim 14, wherein providing the monitoring information to the remote device includes electronically communicating the monitoring information to the remote device to report on behaviors of an occupant of the target vehicle, and wherein providing the monitoring information improves reporting about the target vehicle when the target vehicle is unable to communicate the monitoring information to the remote device.
